(19) United States
(12) Patent Application Publication
(10) Pub. No.: US 2007/0283584 A1
(43) Pub. Date: Dec. 13, 2007

(54) Portable Visible Light Beam Pointing Devices, And Thumb Pressure Mounted Fixtures

(75) Inventors: Shahar Harari, Tel Aviv (IL); Paul Steiner, Bikat Beit Hakerem (IL); Gabriel Kohner, Upper Galilee (IL)

Correspondence Address: NATH & ASSOCIATES, 112 South West Street, Alexandria, VA, 22314, US

(73) Assignee: Kapro Industries Ltd., Bikat Beit Hakerem (IL)

(21) Appl. No.: 11/667,592

(22) PCT Filed: Nov. 8, 2005
(86) PCT No.: PCT/IL05/01170

§ 371 Date: May 11, 2007

Related U.S. Application Data
(60) Provisional application No. 60/627,046, filed on Nov. 12, 2004.
(60) Provisional application No. 60/642,676, filed on Jan. 11, 2005.
(60) Provisional application No. 60/700,332, filed on Jul. 19, 2005.
(60) Provisional application No. 60/730,839, filed on Oct. 28, 2005.

(30) Foreign Application Priority Data
Jun. 28, 2005 (IL) 169,436

(51) Int. Cl. G01C 5/00; A47F 5/08

(52) U.S. Cl. 33/290; 248/231.9

(57) ABSTRACT

The present invention is directed toward portable visible light beam pointing devices for set out, marking, and other handyman purposes, and thumb pressure mounted fixtures fashioned as hooks, hook racks, wall mounts, and the like. The pointing devices include a light beam generator, and a pair of orthogonal bubble vials for indicating the orientation of the pointing device along orthogonal axes in a horizontal plane. The thumb pressure mounted fixtures have a body member and at least one thumb tack-like member with a central portion having a steel spike transversely directed relative to the body member for driving into a supporting surface. The thumb tack-like members are intended to be manually collapsible from an arc shaped inoperative configuration with a concealed spike to a generally M-shaped operative configuration with an exposed spike for driving into a supporting surface.

### FIELD OF THE INVENTION

The invention pertains to portable visible light beam pointing devices, and thumb pressure mounted fixtures.

### BACKGROUND OF THE INVENTION

Visible light beam pointing devices are employed by professional tradesmen and Do-It-Yourselfers for a wide range of marking and layout purposes. Exemplary visible light beam pointing devices are illustrated and described in U.S. Pat. No. 5,864,956 to Dong, and GB 2 389 194.

Wall mounted fixtures are employed for a wide range of uses in the home, the office, and the like. Certain wall mounted fixtures are intended for mounting on supporting surfaces made from wood, plasterboard, and the like, on application of thumb pressure. Such thumb pressure mounted fixtures include inter alia thumb tacks, drawing pins, and the like.

### SUMMARY OF THE INVENTION

The first aspect of the present invention is directed toward portable visible light beam pointing devices for set out, marking, and other handyman purposes. The pointing devices include a rigid plastic housing having a topside and an underside for placing on a surface, a light beam generator for selectively pointing a visible light beam along a longitudinal axis, and a pair of orthogonal bubble vials viewable from the topside for indicating the orientation of the pointing device along the X-axis and the Y-axis in a horizontal X-Y plane. The light beam generator can be manually operated by an ON/OFF switch or a pressure operated switch on pressing the pointing device's underside on a surface. In the latter case, the pointing device includes a POWER ON/OFF switch. Pointing devices can be preferably provided with elastomer holders for frictionally holding the shanks of fasteners, for example, nails, tacks, and the like, upright with respect to a surface for facilitating, say, hanging pictures at the same height along a wall. Such bi-material pointing devices can be manufactured using conventional manufacturing techniques, such as, double shot molding. Pointing devices can be provided with a strong ceramic magnet for detecting the presence of a ferrous metal object, for example, studs, noggins, and the like, beneath a surface. Pointing devices can be configured for quick release inter-engagement on quick release mounts, for example, for sliding along a rule-like member, attaching to a vertical supporting surface, and the like. Quick release inter-engagements can be magnetic, interference fit, and the like.

The second aspect of the present invention is directed toward thumb pressure mounted fixtures fashioned as hooks, hook racks, wall mounts, and the like, for mounting on supporting surfaces made from wood, plasterboard, and the like. The thumb pressure mounted fixtures have a planar body member for placing flat on a supporting surface and at least one thumb tack-like member with a central portion having a steel spike transversely directed relative to the body member for driving into a supporting surface. The thumb tack-like members are intended to be manually collapsible from an arc shaped inoperative configuration with a concealed spike to a generally M-shaped operative configuration with an exposed spike for driving into a supporting surface.

Thumb tack-like members can have steel spikes disposed at different angles for different applications, different supporting surfaces, and the like. The steel spikes can be pin-shaped, barb-shaped, and the like.

Thumb tack-like members are preferably formed of suitable plastic material such as polypropylene (PP), polyoxymethylene (POM), and the like, capable of being formed with so-called “living hinges” for multiple use. The thumb pressure mounted fixtures are preferably formed as injection molded plastic monolithic structures including a body member and at least one thumb tack-like member. Alternatively, thumb pressure mounted fixtures may have bi-material structures, for example, a metal body member and at least one plastic thumb tack-like member.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a combined pictorial view and block diagram of a visible light beam pointing device with a holder for holding a fastener's shank upright relative to a surface;

FIG. 2 is a bottom view of FIG. 1's pointing device;

FIG. 3 is a pictorial view of the use of FIG. 1's pointing device;

FIG. 4 is a pictorial view of a visible light beam pointing device with alternative holders for holding a fastener's shank upright relative to a surface;

FIG. 5 is a pictorial view of a third preferred embodiment of a visible light beam pointing device and a quick release mount for mounting the pointing device on a rule-like member;

FIG. 6 is a top view of FIG. 5's pointing device;

FIG. 7 is a cross section of FIG. 5's pointing device along line A-A in FIG. 6;

FIG. 8 is a top view of FIG. 5's quick release mount;

FIG. 9 is a cross section of FIG. 5's quick release mount along line B-B in FIG. 8;

FIG. 10 is a top view of FIG. 5's pointing device mounted on the rule-like member;

FIG. 11 is a cross section of FIG. 10's assembly along line C-C in FIG. 10;

FIG. 12 is a pictorial view of a wall mount with a pair of thumb tack-like members for mounting FIG. 5's pointing device on a supporting surface;

FIG. 13 is a top view of FIG. 5's pointing device mounted on FIG. 12's wall mount at 45°;

FIG. 14 is a pictorial view of a hook with a single thumb tack-like member in an arc-shaped inoperative configuration;

FIG. 15 is a front view of FIG. 14's hook;

FIG. 16 is a side view of FIG. 14's hook;

FIG. 17 is a longitudinal cross section of the FIG. 14's hook along line D-D in FIG. 15;

FIG. 18 is a pictorial view of FIG. 14's hook with its thumb tack-like member in an M-shaped operative configuration;

FIG. 19 is a front view of FIG. 18's hook;

FIG. 20 is a longitudinal cross section of FIG. 18's hook along line E-E in FIG. 19; and

FIG. 21 is a transverse cross section of FIG. 18's hook along line D-D in FIG. 19.

### DETAILED DESCRIPTION OF PREFERRED EMBODIMENTS OF THE PRESENT INVENTION

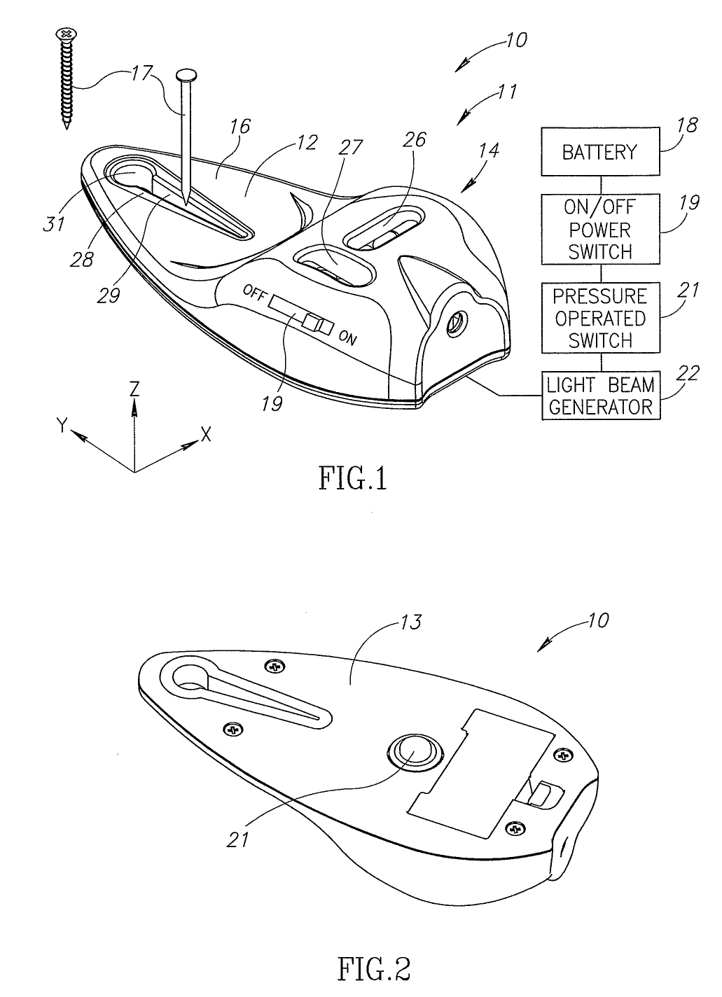

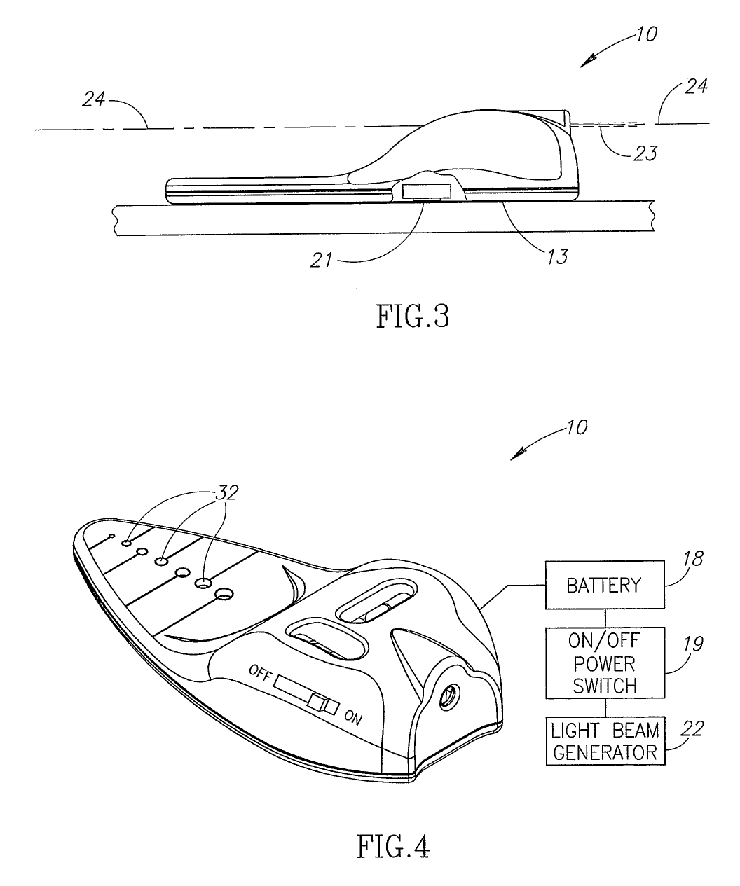

FIG. 1 shows a visible light beam pointing device 10 including a generally kite shaped housing 11 formed from a suitable rigid plastic material such as ABS, and the like, and having a topside 12, and an underside 13. The housing 11 includes a handheld base 14 and a holder 16 for holding fasteners 17, for example, nails, screws, and the like, upright with respect to a surface. The base 14 houses a battery 18, a manually operable POWER ON/OFF switch 19, and a pressure operated switch 21 for energizing a light beam generator 22 on pressing the underside 13 on a surface, for example, a wall, for issuing a visible light beam 23 along a longitudinal axis 24 (see FIG. 3). Suitable light beam generators 22 include laser diodes, Light Emitting Diodes (LEDs), and the like. The housing 11 has a horizontal bubble vial 26 and a vertical bubble vial 27 clearly visible from the topside 12 for indicating the orientation of the pointing device 10 along the X axis and the Y axis in a horizontal X-Y plane, respectively.

The holder 16 includes a generally isosceles shaped elongated inset 28 with a similar shaped elongated slot 29 deployed lengthwise along the longitudinal axis 24. The inset 28 is preferably formed from elastomer impact resistant material for frictionally holding a fastener's shank, and also to withstand impacts, say, in the case that the pointing device 10 is holding a nail to be hammered into a wall, thereby protecting the pointing device 10 from damage. Suitable elastomer materials include thermoplastic rubber (TPR), and the like. The isosceles shaped slot 29 enables the holder 16 to hold fasteners with different diameter shanks. The isosceles shaped slot 29 preferably terminates in a generally circular release aperture 31 for enabling convenient removal of the pointing device 10 after driving a fastener into a surface. The release aperture 31 has a diameter larger than the diameters of the widest heads of fasteners intended to be used with the pointing device 10 such that the pointing device 10 can be released by sliding the pointing device 10 along a fastened fastener until the fastener is disposed in the release aperture 31.

The pointing device 10 can be provided with alternative holders 16 for holding fasteners upright with respect to a surface, for example, a series of throughgoing bores 32 of different diameters for holding fasteners with shanks of different diameter (see FIG. 4). The bores 32 preferably include O-rings 33 (not shown) for frictionally holding a fastener's shank.

The use of the pointing device 10 is now described for hanging pictures on a wall. A user holds the pointing device against the wall using his left hand, inserts a nail through the holder at a first picture hanging position, and then hammers the nail into the wall. The user moves to a second picture hanging position. The user powers on the pointing device and holds the pointing device against the wall to close the pressure operated switch to energize the light beam generator to issue a visible light beam. The user ensures that the pointing device is level and either raises or lowers the pointing device until the visible light beam intercepts the nail at the first picture hanging position. The user inserts a second nail through the holder and proceeds to hammer it into the wall. The user repeats the above for another one or more nails thereby conveniently ensuring that all the nails are at the same height along the wall.

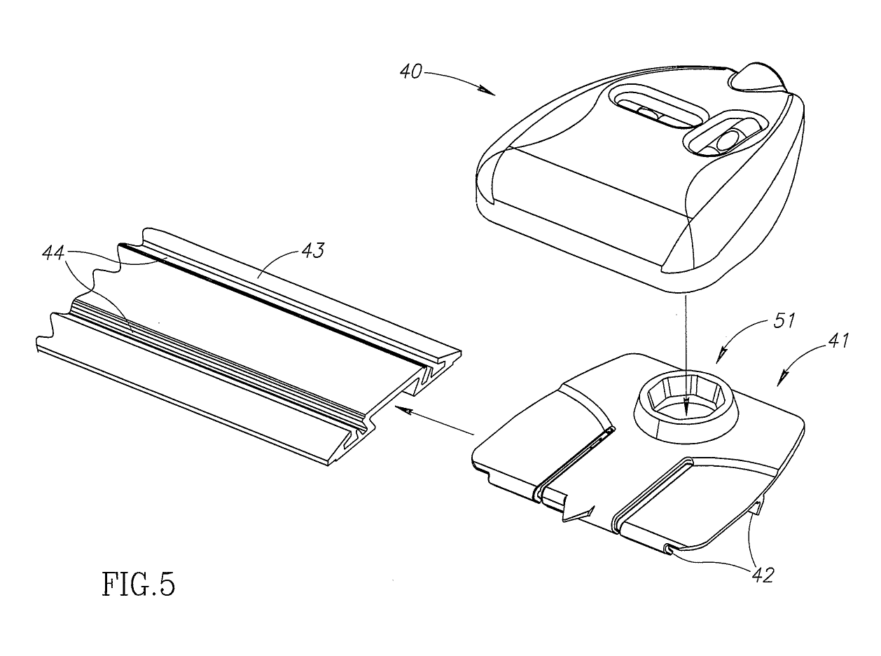

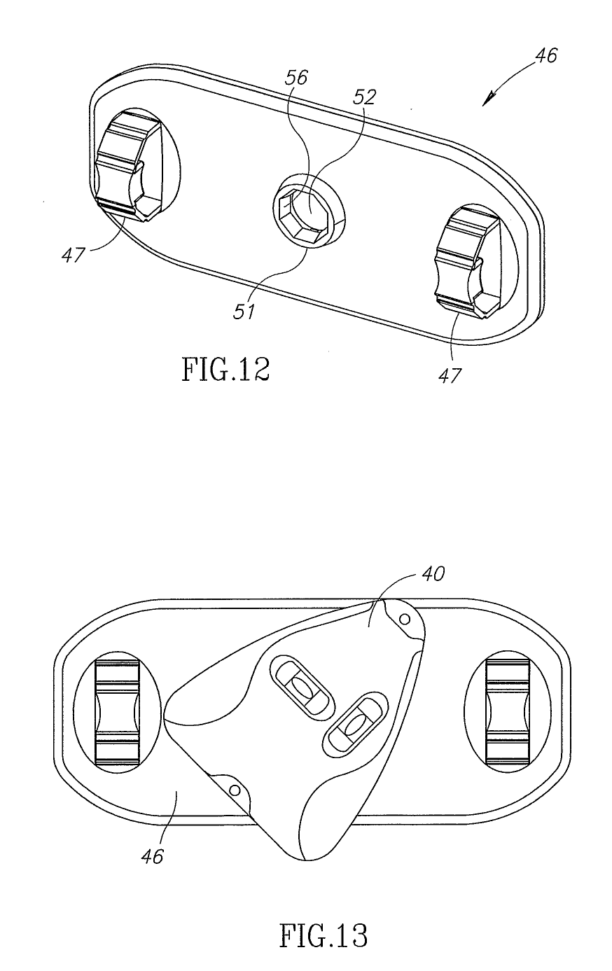

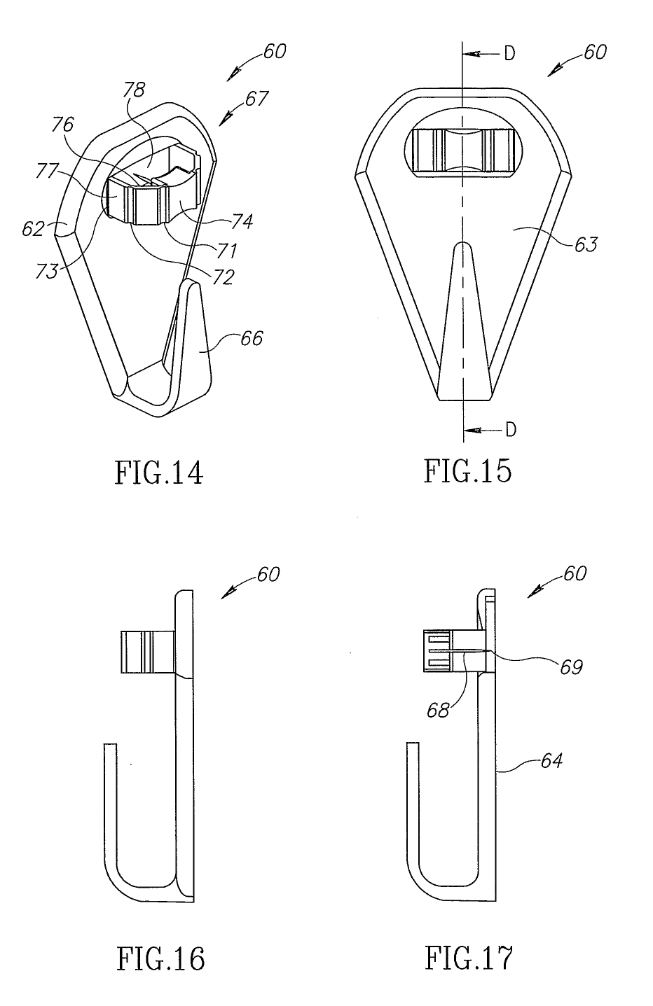

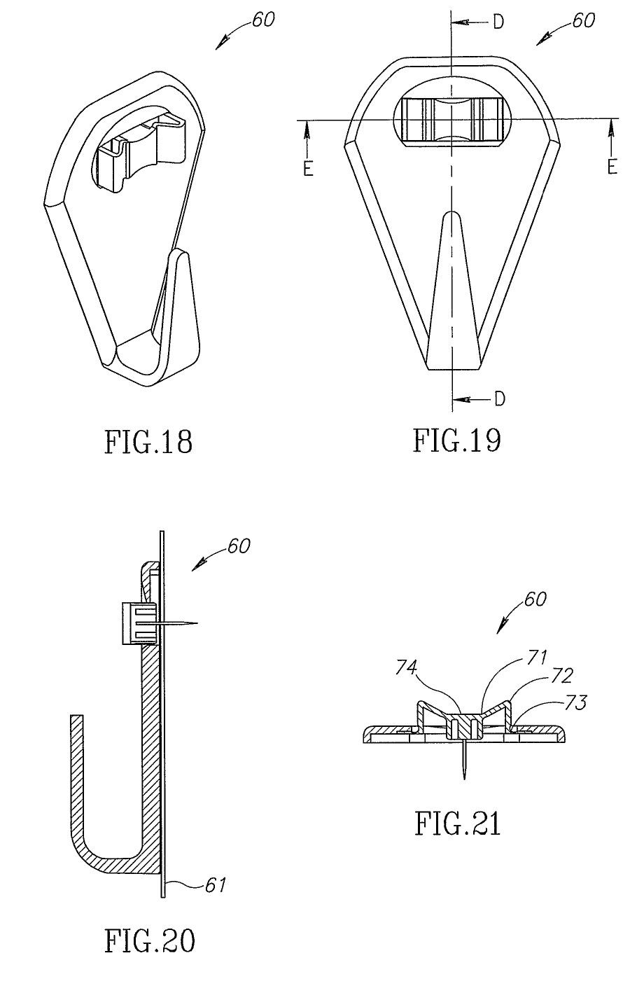

FIG. 5 shows a visible light beam pointing device 40 similar to the pointing device 10 but differing therefrom insofar that it has a magnetic underside 13 for finding buried ferrous objects on placing the underside 13 thereon, and enabling hands free use, and doesn't have a holder 16. Hands free use is achieved by magnetically mounting the pointing device 40 on either a quick release mount 41 with a pair of tabs 42 for sliding along a rule-like member 43 having a pair of parallel and opposite retaining tracks 44, or a wall mount 46 with a pair of thumb tack-like members 47 for mounting the wall mount 46 on a supporting surface, for example, wood, plasterboard, and the like (see FIG. 12). The construction and operation of the thumb tack-like members 47 are described hereinbelow with reference to FIGS. 14-21.

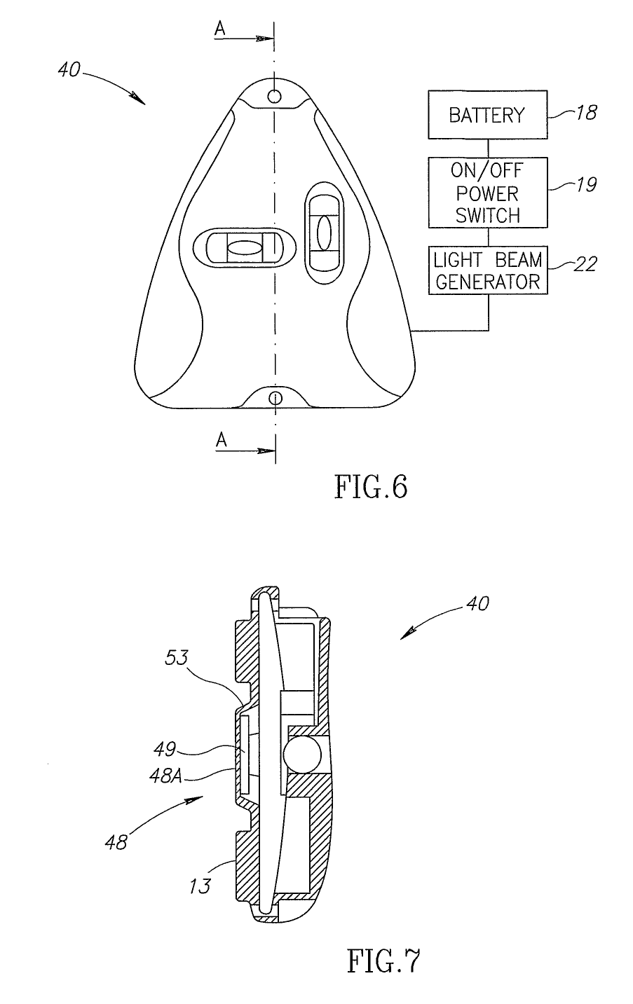

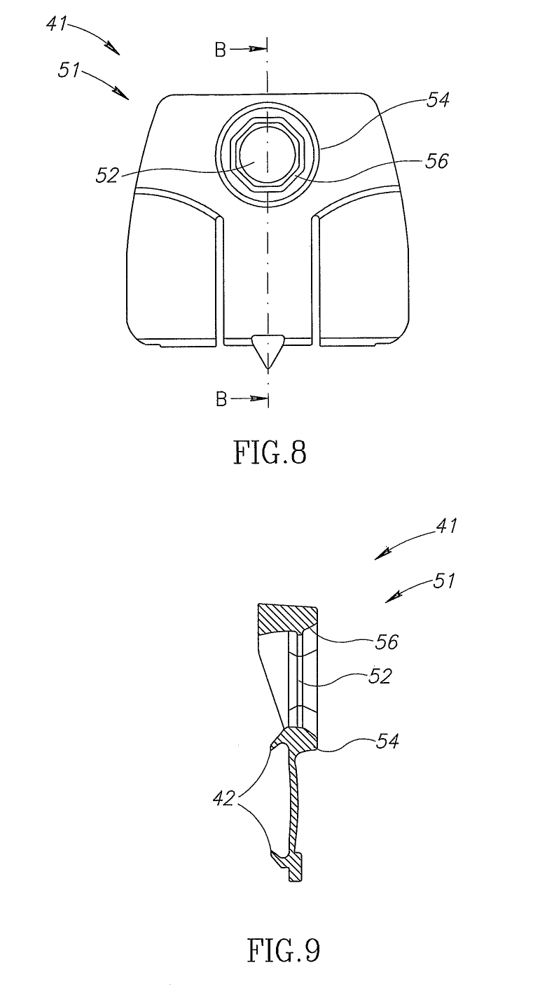

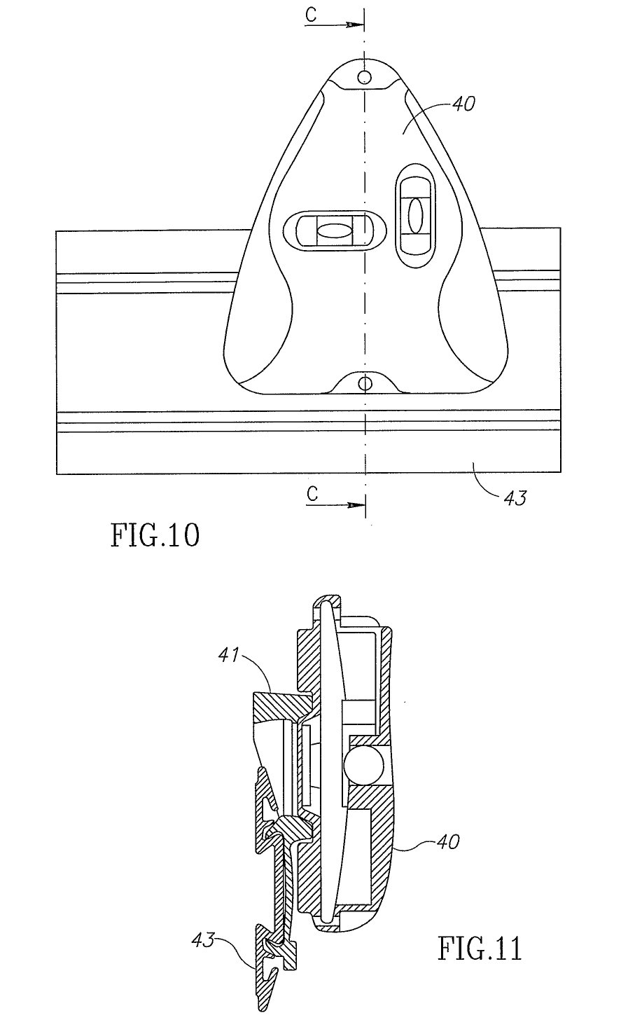

The pointing device 40 includes a magnetized recessed male connector 48 with a strong ceramic magnet 49 for magnetically coupling on identical ferrous female connectors 51 with a ferrous element 52 provided on the quick release mount 41 and the wall mount 46 (see FIGS. 6 and 7). The recessed male connector 48 has a front surface 48A preferably flush with the underside 13 such that the underside 13 remains planar. The recessed male connector 48 has an octagon shaped projection 53 and the female connectors 51 have a thin walled surround 54 with a complementary octagon shaped inner surface 56 for enabling deployment of the pointing device 40 at eight different orientations at 45° increments (see FIGS. 8 and 9). FIGS. 10 and 11 show the pointing device 40 mounted on the rule-like member 43 at 90°. FIG. 13 shows the pointing device 40 mounted on the wall mount 46 at 45°.

FIGS. 14 to 21 show a hook 60 for mounting on a flat supporting surface 61 (see FIG. 21) made of wood, plasterboard, and the like. The hook 60 includes a generally kite-shaped planar body member 62 having a topside 63 and an underside 64, and downwardly tapering to a hooked end 66. The body member 62 includes a single thumb tack-like member 67 with a steel spike 68 having a tip 69 and transversely directed relative to the body member 62. The thumb tack-like member 67 has three pairs of opposite pre-formed hinges 71, 72 and 73 delimiting a centerpiece 74 with the steel spike 68, a first pair of opposite segments 76 lateral to the centerpiece 74, and a second pair of opposite segments 77 intermediate the first pair of opposite segments 76 and the body member 62. The thumb tack-like member 67 extends across a throughgoing aperture 78 formed in the body member 62.

The thumb tack-like member 67 is manually collapsible from an arc shaped inoperative configuration with a concealed spike 68 to a generally M-shaped operative configuration with an exposed spike 68 on application of thumb pressure on its centerpiece 74 toward the body member 62 for driving the spike 68 into the supporting surface 61 for affixing the hook 60 thereto. The controlled collapse of the thumb tack-like member 67 is enabled by the hinges 71 and the hinges 72 undergoing inflection and the hinges 73 undergoing a relatively minor converging angular movement. The spike 68 is dimensioned lengthwise such that its tip 69 stops slightly short of the underside 64 in the arc shaped inoperative configuration so as not to interfere with placing the hook 60 on a supporting surface 61 but not to unduly reduce the length available for insertion into a supporting surface in the M-shaped operative configuration. The thumb tack-like member 67 can be restored to its arc shaped inoperative configuration for re-using the hook 60 on pulling the centerpiece 74 away from the body member 62.

While the invention has been described with respect to a limited number of embodiments, it will be appreciated that many variations, modifications, and other applications of the invention can be made within the scope of the appended claims.

1. Portable visible light beam pointing device comprising:
(a) a housing having a topside and an underside for placing on a surface;
(b) a light beam generator for selectively pointing a visible light beam along a longitudinal axis; and
(c) a pair of orthogonal bubble vials viewable from said topside for indicating the orientation of the pointing device along orthogonal axes in a horizontal plane.

2. The device according to claim 1 wherein said housing includes a holder for holding a fastener's shank upright with respect to a surface, said holder including at least one throughgoing aperture along said longitudinal axis.

3. The device according to claim 2 wherein said holder includes a generally isosceles shaped elongated slot deployed lengthwise along said longitudinal axis.

4. The device according to claim 2 wherein said holder includes at least two different sized bores along said longitudinal axis for holding fasteners with different diameter shanks.

5. The device according to any one of claims 2 to 4 wherein said holder includes elastomer material for frictionally holding a fastener's shank upright with respect to a surface.

6. The device according to any one of claims 1 to 5 wherein said housing includes a pressure operated switch for energizing said light beam generator on pressing said underside on a surface.

7. The device according to any one of claims 1 to 6 wherein said housing includes a magnetic underside for detecting the presence of a ferrous metal object beneath a surface on placing said underside thereon.

8. The device according to any one of claims 1 to 7 wherein said underside includes a male connector for quick release inter-engagement on a female connector of a quick release mount at preset orientations.

9. The device according to claim 8 wherein said underside includes a recessed male connector whereby said underside is a planar.

10. A combination comprising:
(a) a visible light beam pointing device according to any one of claims 7 to 9; and
(b) a quick release mount for sliding along a rule-like member with at least one longitudinally directed retaining track.

11. The combination according to claim 10 and further comprising said rule-like member.

12. A combination comprising:
(a) a visible light beam pointing device according to any one of claims 7 to 9; and
(b) a wall mount having at least one arc-shaped thumb tack-like member for mounting the wall mount on onto a supporting surface.

13. A thumb pressure mounted fixture comprising a planar body member for placing flat on a supporting surface, and at least one thumb tack-like member each having a central portion with a spike transversely directed relative to said body member, each said at least one thumb tack-like member on application of thumb pressure on its central portion toward said body member being manually collapsible from an arc shaped inoperative configuration with a concealed spike to a generally M-shaped operative configuration with an exposed spike for driving into the supporting surface for affixing the fixture thereto.

14. The fixture according to claim 13 wherein each said at least one thumb tack-like member includes pre-formed hinges for delimiting a centerpiece hingedly mounted with respect to said body member.

15. The fixture according to claim 14 wherein each said at least one thumb tack-like member includes three pairs of opposite and parallel pre-formed hinges for delimiting said centerpiece with said spike, a first pair of opposite segments lateral to said centerpiece, and a second pair of opposite segments intermediate said first pair of opposite segments and said body member.

16. The fixture according to any one of claims 13 to 15 wherein each said at least one thumb tack-like member extends across a throughgoing aperture formed in said body member.

17. The fixture according to any one of claims 13 to 16 wherein said body member and said at least one thumb tack-like member are an injection molded plastic monolithic structure.

18. A hook comprising a thumb pressure mounted fixture according to any one of claims 13 to 17 with a single thumb tack-like member, and a hooked end.

19. A wall mount comprising a thumb pressure mounted fixture according to any one of claims 13 to 17 with a pair of spaced apart thumb tack-like members, and a female connector for quick release inter-engagement with a male connector.

20. The wall mount according to claim 19 wherein said quick release inter-engagement enables deployment of said male connector at preset orientations relative to said female connector.

21. The wall mount according to claim 19 wherein said male connector has a magnet and said female connector has a ferrous element for rendering a magnetic quick release inter-engagement.
